(19) United States
(12) Patent Application Publication
(10) Pub. No.: US 2024/0056412 A1
(43) Pub. Date: Feb. 15, 2024

(54) UNDERLAY PATH SELECTION IN FABRIC/OVERLAY ACCESS NETWORKS

(71) Applicant: Cisco Technology, Inc., San Jose, CA (US)

(72) Inventors: Prakash C. Jain, Fremont, CA (US); Sanjay Kumar Hooda, Pleasanton, CA (US); Denis Neogi, Kanata (CA)

(21) Appl. No.: 17/886,942

(22) Filed: Aug. 12, 2022

(51) Int. Cl. H04L 61/103; H04L 61/5084; H04L 12/46

(52) U.S. Cl. CPC H04L 61/103; H04L 61/5084; H04L 12/4633

(57) ABSTRACT

Techniques and architecture are described for service and/or application specific underlay path selection in fabric access networks. An egress tunnel router (ETR) registers service requirements of a connected application server, e.g., an end point known by host/device detection, config, or CDC type protocols, to a fabric control plane, e.g., a map server/map resolver (MSMR). The fabric control plane, while replying to a map request from an ingress tunnel router (ITR), sends service parameters in the map reply. While installing a tunnel forwarding path in hardware, i.e., map cache, the ITR may utilize a probing mechanism to ensure that the ITR chooses the right underlay adjacency, e.g., routing locator(s) (RLOC(s)), that can satisfy the service requirements provided by the fabric control plane. Only RLOC(s) that comply with the service requirements are installed in the map cache along with the required service parameters.

### TECHNICAL FIELD

The present disclosure relates generally to underlay path selection in access networks, and more particularly, to service and/or application specific underlay path selection in fabric access networks.

### BACKGROUND

Modern networks often consist of multiple types of networks integrated such that the multiple networks function as a single network from the perspective of users. For example, fabric networks (access networks) may utilize one or more transit networks to communicate with a remote network such as, for example, an on-premises network, an internet network, a cloud network, or a hybrid cloud network. Fabric networks thus allow source hosts to communicate with remote hosts that provide various services and/or applications. Thus, the fabric networks are generally local network sites utilizing transit network sites to allow hosts to communicate with remote destination network sites (e.g., on-premises networks, internet networks, cloud networks, and hybrid cloud networks). As is known, there may be many transit networks or sites in between the local network/site and the remote destination network/site.

With such network arrangements, the number of end points are continuously increasing (cell phones, notebooks, internet-of-things (IoT) devices, portable devices, etc.). Such end points often desire and/or need services from a remote destination network, e.g., a cloud or hybrid cloud network. To provide seamless connectivity and mobility at scale, overlay fabric networks have evolved and become necessary for the majority of future networks.

Such fabric networks generally consist of connected switches/data center servers in a site and multiple sites (of connected switches/data center servers) are connected via multi-site networks, e.g., software defined wide area access (SD-WAN), internet protocol/virtual private network (IP/VPN), software defined access (SDA) transit, etc. Overlay packets traverse though multiple underlay paths within the site and across the multi-site networks.

The end points on these networks access different services and/or applications (on-premises, cloud, hybrid cloud, etc.). There are different requirements for each kind of services these end points need or desire. For example, multimedia/camera application/services need faster protocols as opposed to general user datagram protocol (UDP)/transmission control protocol (TCP). An example of such a new protocol includes QUIC, which has different underlay requirements than general UDP/TCP since QUIC attempts to use the highest maximum transmission unit (MTU) size in order to increase through-put.

Similarly, IoT devices for 5G applications/services may have different timing/performance/latency requirements that require choosing the underlay path for overlayed tunnels that can satisfy those requirements. Current fabric networks generally only consider/check underlay connectivity (single or multi-path/equal cost multi-path (ECMP) routing) without having any mechanism for selecting among the underlay paths that can satisfy overlay service/application requirements. Additionally, some of the application specific integrated circuits (ASICs) forwarding engines do not have a capability of setting appropriate MTUs specific to a path within a network or networks (routing locator (RLOC)) or choosing among multiple underlay paths as per the service (or application) requirements.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 schematically illustrates an example of a network arrangement that includes underlay paths through networks within the network arrangement.

FIGS. 2A-2C schematically illustrate example workflows for service and/or application specific underlay path selection in fabric access networks, in accordance with the techniques and architecture described herein.

FIG. 3 illustrates a flow diagram of an example method for service and/or application specific underlay path selection in fabric access networks, in accordance with the techniques and architecture described herein.

FIG. 4 is a computer architecture diagram showing an example computer hardware architecture for implementing a device that can be utilized to implement aspects of the various technologies presented herein.

### DESCRIPTION OF EXAMPLE EMBODIMENTS

### Overview

The present disclosure describes techniques and architecture that provide a service infrastructure-based mechanism allowing for underlay paths that satisfy certain service requirements, e.g., a maximum transmission unit (MTU) size specification for packets, network bandwidth, network congestion, network loss delay, network quality of service (QoS), and class of service (CoS) specifications for packets. With such a mechanism, an egress tunnel router (ETR) registers service requirements of a connected application server, e.g., an end point known by host/device detection, config, or CDC type protocols, to a fabric control plane, e.g., a map server/map resolver (MSMR). The fabric control plane, while replying to a map request from an ingress tunnel router (ITR), sends service parameters in the map reply. While installing a tunnel forwarding path in hardware, i.e., map cache, the ITR may utilize a probing mechanism to ensure that the ITR chooses the right underlay adjacency, e.g., routing locator(s) (RLOC(s)), that can satisfy the service requirements provided by the fabric control plane. Only RLOC(s) that comply with the service requirements are installed in the map cache along with the required service parameters. All additional service parameters in control messages, e.g., locator ID separation protocol (LISP) control messages, are added using vendor specific private type length values (TLVs), e.g., LCAFs in LISP.

In particular, as an example, a LISP-based software defined access (SDA) fabric network for a service (such as, for example, QUIC applications), that has underlay requirements of MTU size greater than 1200 may be described. Even though the MTU size requirement in the LISP-based SDA fabric network is provided as an example, the present disclosure described herein is applicable and may be extended to any service requirements for selecting underlay paths and may be implemented via any pull-based overlay software defined networking (SDN) network/protocols, for example, border gateway protocol (BGP)/ethernet virtual private network (EVPN), e.g., protocols that operate in a centralized fashion.

For SDA fabric networks, LISP may register the MTU size and any other service properties from a service border and may handle dynamic changes for service MTU size. A LISP ITR may use special service verify RLOC probes to test/evaluate and pick correct RLOC/adjacency path to install in map cache for a service/application. The techniques may also be extended across multi-site networks using transit/cloud control planes (T-MSMR).

Thus, the techniques and architecture described herein allow for a remote destination host to register with a control plane within its network site, e.g., an internet, cloud, or hybrid cloud network, etc. When registering with the control plane, the remote destination host may provide one or more service parameters, e.g., a maximum transmission unit (MTU) requirement. The control plane may then publish the service requirements to other borders within the remote site. Additionally, the control plane may publish the service requirements to a control plane of one or more transit networks. A single control plane may serve as a control plane for the one or more transit networks. Alternatively, each transit network may have their own control plane, in which case the control plane of the remote network may provide the service requirements for the remote destination host to all of the control planes of the transit networks.

The control plane of the transit network may publish the service requirements to borders within the transit network. The control plane may also provide the service requirements to a control plane of a local network, e.g., a fabric access network. The control plane of the local network may publish the service requirements to borders of the local network site. Additionally, in configurations, the control planes may publish the service requirements to underlay switches within their respective network sites.

When a local host wishes to communicate, e.g., exchange traffic, with the remote destination host, the host may register with a border of the local network, which may then send a map request to the local network control plane. In configurations, the local network control plane is a MSMR. The control plane may send a map reply back to the border, which is serving as a forwarding edge for the local host, to forward to the local host. The map reply may include RLOCs for the various paths, e.g., tunnels, within the underlay of the various networks. The RLOCs may also include network devices along the various tunnels.

In configurations, the local site border serving as the forwarding edge may send a probe that fits the various characteristics or service requirements for the remote destination host along the various tunnels or paths. Upon receiving a reply from the remote destination host along one or more tunnels, the local border now knows which RLOCs (paths) satisfy the service requirements of the remote destination host. The local border may then store the RLOCs (paths) that satisfy the requirements within a map cache at the border. If a reply to the verification probe is not received by the border, then the border realizes that the path includes at least a portion that does not satisfy the service requirements of the remote destination host as the probe did not make it to the remote destination host, e.g., the probe timed out.

In configurations, e.g., in different network topologies, the forwarding edge (local site) may forward the probes to borders of its network and wait for the replies. The second borders may then forward probes to third borders at the transit network. This allows the second borders to verify portions of the overall path within the transit networks. The third borders at the transit network site may then forward probes along the segments within the remote destination network site to thereby verify the segments within the remote destination network site that satisfy the service requirements. Each border may store the RLOCs (paths) within the corresponding networks within their own map caches.

If the remote destination host's service requirements change, then the process may be repeated and the appropriate RLOCs may be stored within the various map caches of the borders. The RLOCs within the map caches that are no longer viable, e.g., do not meet the remote host destination service requirements, may be deleted from the map cache within the corresponding borders. Likewise, if the local host attempts to send a packet that is too large, e.g., exceeds the MTU characteristics of the various paths, then a message, e.g., ICMP type 3 code 4 message, may be provided to the local host to change the packet size to meet the MTU characteristics of the path for the traffic between the local host and the remote destination host. In such configurations, the “do not fragment” (DF) bit is generally set at the local host since in this example, the remote host is configured as a QUIC server.

In configurations, a path may change, e.g., it may no longer be acceptable. For example, a previously acceptable path that met the service requirements of the remote destination host may now have one or more segments where the congestion is too high, there is a bandwidth issue, too many packets are being dropped, a link failure, or some other type of problem within the network, resulting in an approved path no longer being acceptable. Thus, the process may be repeated in order to select a new acceptable path if no other acceptable paths are currently known. In configurations, during initial selection of an acceptable path, there may be multiple paths that are acceptable and thus, there may already be an acceptable path within the map caches of the borders.

As an example, a method may include in response to a map request from a network device, receiving, from a control plane at the network device, a map reply related to a destination host, wherein the map reply includes service requirements of the destination host. The method may also include determining, by the network device, an underlay path between the network device and the destination host, wherein the underlay path meets or exceeds the service requirements. The method may further include selecting the underlay path for traffic between a source host the destination host.

In configurations, determining the underlay path may comprise in response to determining the underlay path is not located in a cache, sending, by the network device to the destination host, a probe message, and based at least in part on receiving a reply message from the destination host, determining the underlay path.

In configurations, the method may also include verifying the underlay path. In such configurations, the method may further include saving, by the network device in a cache, the underlay path. In such configurations, determining the underlay path may comprise determining the underlay path is located in the cache.

In configurations, verifying the underlay path may comprise sending, by the network device to the destination host, a probe message, and based at least in part on receiving a reply message from the destination host, verifying the underlay path.

In configurations, the service requirements may comprise one or more of a maximum transmission unit (MTU) specification for packets, network bandwidth, network congestion, network loss delay, network quality of service (QoS), or class of service (CoS) specifications for packets.

In configurations, the method may additionally comprise receiving, from a local host at a border within a network that includes the network device, a packet having a size exceeding the MTU specification for at least a portion of the underlay path located within the network, and forwarding, by the border, a message to the local host instructing the local host to adjust packet sizes for subsequently transmitted packets.

In configurations, the underlay path is a first underlay path and the method may further comprise determining the first underlay path no longer satisfies the service requirements, and determining a second underlay path.

In configurations, determining the second underlay path may comprise in response to determining the second underlay path is not located in a cache, sending, by the network device to the destination host, a probe message, and based at least in part on receiving a reply message from the destination host, determining the second underlay path.

In configurations, the method may further comprise verifying the second underlay path, saving, by the network device in a cache, the second underlay path, and deleting the first underlay path from the cache, wherein determining the underlay path comprises determining the underlay path is located in the cache.

In configurations, verifying the second underlay path may comprise sending, by the network device to the destination host, a probe message, and based at least in part on receiving a reply message from the destination host, verifying the second underlay path.

Thus, the techniques and architecture described herein provide for selecting underlay paths for services and/or applications based on requirements of the services and/or applications.

The techniques described herein may be performed by a system and/or device having non-transitory computer-readable media storing computer-executable instructions that, when executed by one or more processors, performs the method described above.

### Example Embodiments

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

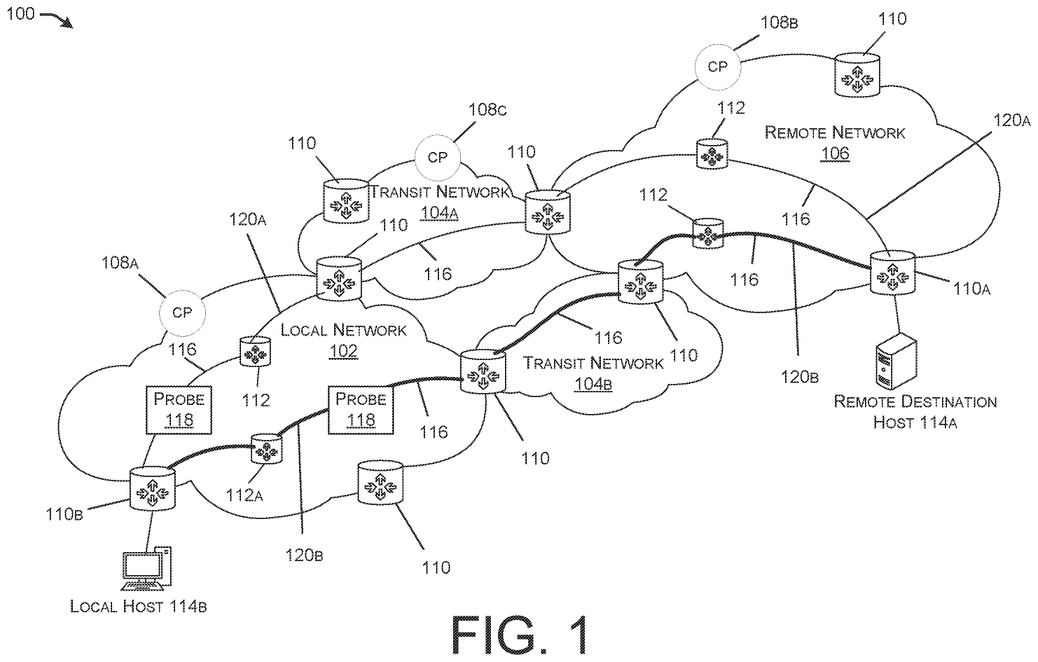

FIG. 1 schematically illustrates an example of a network arrangement 100. The network arrangement 100 includes a first or local network or site 102. In configurations, the first network 102 is configured as an access network, e.g., a fabric network, and thus, may be referred to herein as fabric network 102. The network arrangement 100 further includes a first transit network 104a and a second transit network 104b. The transit networks 104a, 104b may be operated by different network operators and may comprise one or more of wireless network portions and/or wired network portions. The network arrangement 100 also includes a second or remote network or site 106. In configurations, the second network 106 is configured as an Internet network, a cloud network, or a hybrid cloud network. The transit networks 104 couple the first network 102 and the second network 106. As is known, multiple transit networks may be used in series to couple the first network 102 and the second network 106.

The first network 102 includes a control plane 108a and the second network includes a control plane 108b. A control plane 108c controls the transit networks 104a, 104b, although in configurations each transit network 104 may have its own control plane.

Each network 102, 104, 106 includes network devices that may be in the form of routers and serve as borders (and/or forwarding edges) 110. The networks 102 and 106 also include underlay switches 112. Hosts 114 access the networks 102 and 106.

In configurations, as an example, the fabric network 102 is configured as a LISP-based software defined access (SDA) fabric network. Remote destination host 114a provides a service such as, for example, QUIC applications, that has underlay requirements of MTU size greater than 1200. Even though the MTU size requirement in the fabric network 102 is provided as an example, the present disclosure described herein is applicable and may be extended to any service requirements for selecting underlay paths and may be implemented via any pull-based overlay software defined networking (SDN) network/protocols, for example, border gateway protocol (BGP)/ethernet virtual private network (EVPN), e.g., protocols that operate in a centralized fashion.

For the fabric network 102, LISP may register the MTU size and any other service properties from a service border 110a, e.g., an egress tunnel router (ETR) with the control plane 108b and may handle dynamic changes for service MTU size. Thus, the remote destination host 114a registers with the control plane 108b within its network site, e.g., an internet, cloud, or hybrid cloud network, etc. When registering with the control plane 108b, the remote destination host 114a may provide one or more service parameters, e.g., a maximum transmission unit (MTU) requirement. The control plane 108b may then publish the service requirements to other borders 110 within the remote site. Additionally, the control plane 108b may publish the service requirements to the control plane 108c of the transit networks 104a, 104b. As previously noted, a single control plane may serve as a control plane for the one or more transit networks 104. Alternatively, each transit network 104 may have their own control plane, in which case the control plane 108b of the remote network 106 may provide the service requirements for the remote destination host 114a to all of the control planes 108 of the transit networks 104.

The control plane 108c of the transit networks 104a, 104b may publish the service requirements to borders 110 within the transit networks 104a, 104b. The control plane 108c may also publish the service requirements to the control plane 108a of the local network 102, e.g., the fabric access network. The control plane 108a of the local network 102 may publish the service requirements to borders 110 of the local network 102. Additionally, in configurations, the control planes 108a, 108b may publish the service requirements to underlay switches 112 within their respective network sites 102, 106.

When a local host 114b wishes to communicate, e.g., exchange traffic, with the remote destination host 114a, the local host 114b may register with a border 110b of the local network. The local network 102 may send a map request to the control plane 108a. In configurations, the local network control plane 108a is configured as a MSMR. The control plane 108a may send a map reply back to the border 110b (which is serving as a forwarding edge for the local host 114b) to forward to the local host 114b. The map reply may include RLOCs for the various paths, e.g., tunnels 116, within the underlay of the various networks 102, 104a, 104b, 106. The RLOCs may also include network devices, e.g., borders 110, along the various tunnels 116.

In configurations, the local network border 110b serving as the forwarding edge may send a verification probe 118 that fits the various characteristics or service requirements for the remote destination host 114a along the various tunnels 116 that form paths. Upon receiving a reply from the remote destination host 114a along one or more tunnels 116, the local border 110b now knows which RLOCs (paths) satisfy the service requirements of the remote destination host 114a, which in this example is a MTU greater than 1200. The local border 110a may then store the RLOCs (paths) that satisfy the requirements within a map cache at the local border 110a. If a reply to the verification probe 118 is not received by the local border 110b, then the local border 110b realizes that the path includes at least a portion that does not satisfy the service requirements of the remote destination host 114a as the verification probe 118 did not make it to the remote destination host 114a, e.g., the probe 118 timed out. Thus, in this example, the local border 110b serves as a LISP ingress tunnel router (ITR) and uses special service verify RLOC probes 118 to test/evaluate and pick correct RLOC/adjacency paths to install in the map cache for the service/application, e.g., the remote destination host 114a configured as a QUIC server that provides QUIC services/applications.

In configurations, the forwarding edge (local border 110b) may forward verification probes 118 to second borders 110c, 110d of local network 102 and wait for the replies. The second borders 110c, 110d may then forward verification probes 118 to third borders 110e, 110f at the transit networks 104a, 104b and remote network 106 and wait for replies. This allows the second borders 110c, 110d to verify portions of the overall path within the transit networks 104a, 104b. The third borders 110e, 110f may then forward probes 118 along tunnels 116 within the remote destination network 106 to the remote border 110a to thereby verify segments (e.g., tunnels 116 and network devices such as the borders 110 and the underlay switches 112) of paths within the remote destination network 106 that satisfy the service requirements of the remote destination host 110a. Each border 110 may store the RLOCs (paths) that satisfy the service requirements within their corresponding networks within their own map caches.

Thus, an overall path of tunnels 116 from the local border 110b in the local network 102 may be created through the local network 102, through the transit network site 104b, and through the remote destination network 106. For example, one or more segments of path 120a do not satisfy the remote destination host's service requirements and thus, path 120a is not acceptable. However, all of the segments of path 120b satisfy the service requirements of the remote destination host 114a and thus, path 120b is an acceptable path for traffic between the local host 114b and the remote destination host 114a. In this example, the remote destination host 114a is configured as a QUIC server. Thus, the segments along the path 120b have an MTU greater than 1200 while one or more of the segments along the path 120a do not have an MTU greater than 1200.

If the remote destination host's service requirements change, then the processes described herein may be repeated and the appropriate RLOCs may be stored within the various map caches of the borders 110. The RLOCs within the map caches that are no longer viable, e.g., do not meet the remote host destination 114a's service requirements, may be deleted from the map caches within the corresponding borders 110.

In configurations, if the local host 114b attempts to send a packet that is too large, e.g., exceeds the MTU characteristics of acceptable path 120b, then a message, e.g., ICMP type 3 code 4 message, may be provided from the control plane 108a to the local host 114b to change the packet size to meet the MTU characteristics of the path 120b for the traffic between the local host 114b and the remote destination host 114a. In such configurations, the “do not fragment” (DF) bit is generally set at the local host 114b since in this example, the remote host 114a is configured as a QUIC server.

In configurations, a path may change, e.g., it may no longer be acceptable. For example, the previously acceptable path 120b that meets the service requirements of the remote destination host 114a may now have one or more segments where the congestion is too high, there is a bandwidth issue, too many packets are being dropped, a link failure, or some other type of problem within a corresponding network, resulting in the approved path 120b no longer being available or possibly acceptable. Thus, the processes described may be repeated in order to select a new acceptable path if no other acceptable paths are currently known, e.g., stored in map cache. In configurations, during initial selection of an acceptable path, there may be multiple paths that are acceptable and thus, there may already be an acceptable path within the map caches of the borders 110.

In particular with respect to this example, LISP x tunnel router (xTR) (e.g., ingress tunnel router (ITR) or egress tunnel router (ETR)) may configure MTU size and other parameters needed by end points services/application, e.g., remote destination host (QUIC server) 114a at a LISP instance or at a service level. The LISP xTR may also configure local RLOC within the control plane, e.g., the control plane 108b (MSMR), that can support the end point/service requirements.

In this example, the ETR, e.g., border 110a, may register service/application MTU size requirements to the control plane 108b (MSMR) with the end point registration. The ETR may also update dynamic changes in the service parameters (e.g., MTU size) to the control plane 108b (MSMR) and may trigger solicit map request (SMR) whenever service parameters or MTU size change for the remote destination host 114a. The LISP border/PXTR/service-ETR, e.g., border 110a, may also register the MTU size and other service parameters needed by the specific service, e.g., remote destination host 114a, to the control plane 108b (MSMR). The LISP border 110a may also update dynamic changes in the service parameters, e.g., MTU size changes, and may trigger SMR whenever service parameters or MTU size change.

When the ITR, e.g., border 110b, sends a map request for an end point/service ETR, the control plane 108a (MSMR) may reply with a map reply that includes service parameters, for example, MTU size requirements (end point identification (EID) parameters in an EID vendor specific LISP canonical address format (LCAF)). The control plane 108a may receive the service parameters from another control plane, e.g., control plane 108c or control plane 108b. The ITR may keep/update MTU size requirements with the remote EID during map cache installation based on the map reply or publication from the control plane 108a (MSMR).

The ITR may send probes, e.g., service verify RLOC probes 118, to each RLOC, e.g., each path, provided in the map reply or the publication from the control plane 108a (MSMR) with a packet size equal to a required MTU size received in the map reply (along with any other service parameter requirements). Thus, the probe message with increased size using dummy records with vendor specific LCAF or regular ping messages may be used. Once the probe/ping reply is received, the RLOC may be updated with the MTU size that the RLOC is able to support during the probe. If the RLOC already has the MTU size set as greater than required by the remote EID, meaning it already provided service verify RLOC probe, the ITR may skip verification probing to avoid any scale issues with probing. The ITR may choose one of those RLOC paths that have the MTU size higher than the remote EID MTU requirement. This may ensure that the RLOC path satisfies the service requirements to install the map cache (service RLOC mapping) for that particular end point/service destination.

The LISP may pass/update to a centralized forwarding module (forwarding information base (FIB)) at the forwarding edge, e.g., border 110b, MTU size with EID and RLOC (based on MTU size requirements of local based on configuration) and remote EIDs (based on RLOC probe test results) with the complying RLOCs. The FIB may then pass to platform/forwarding hardware, e.g., platform/forwarding application specific integrated circuit (ASIC), the remote map cache entry with the complying RLOCs. This way, there is no need for the platform/forwarding hardware to choose RLOCs based on MTU size requirements in case the platform/forwarding hardware does not support it.

The platform/forwarding hardware sets MTU per tunnel adjacency/interface based on remote EID MTU requirements and updates complying RLOCs (given by the control plane) for tunnel encapsulation header. When the platform/forwarding hardware detects any packets that are too big for the MTU, and the “do not fragment” (DF) bit is set, at the fabric edge from the host side traversing over the tunnel, the platform/forwarding hardware changes to software and a regular ICMP process may take over. An ICMP type 3 code 4 may be sent to the host, e.g., host 114b or host 114a, for the host to readjust packet size to satisfy the MTU requirements.

If an underlay node detects a packet that is too large for the MTU (or an underlay path changes due to routing such that the packet is hitting a network device, e.g., a border 110 or underlay switch 112, with a smaller MTU), then that particular node/port may generate an ICMP type 3 code 4, e.g., packet size too big, and provide it to the source (edge or transmit tunnel source RLOC). At the source, the ICMP message is provided for software and the FIB detects that the MTU is too large (based on the ICMP type 3 code 4 being received from the tunnel) and updates the MTU size change to the appropriate RLOC MTU size. This MTU change may be treated as SMR so that both the control planes and the platform/forwarding hardware may update the map cache with the changes. The previous steps for determining appropriate RLOCs and paths based on MTU requirements (and any other service requirements) may then be repeated.

When the MTU change happens in a transit site and is detected at the service-ETR border, e.g., border 110a, the remote map cache may be updated at the borders 110e and/or 110f via the transit control plane, e.g., the transit control plane 108c (MSMR). Then this change may be reflected from the map cache to the corresponding local database mapping entry for service ETR at the border 110a to trigger reregistration of service ETR toward the local site control plane 108a, e.g., SMR. This may further trigger policy change (or SMR) at the local site to update the remote EID map cache entry at the fabric edge (FE), e.g., border 110b.

Thus, the techniques and architecture provide complete end-to-end path MTU discovery (PMTUD) for a service/application.

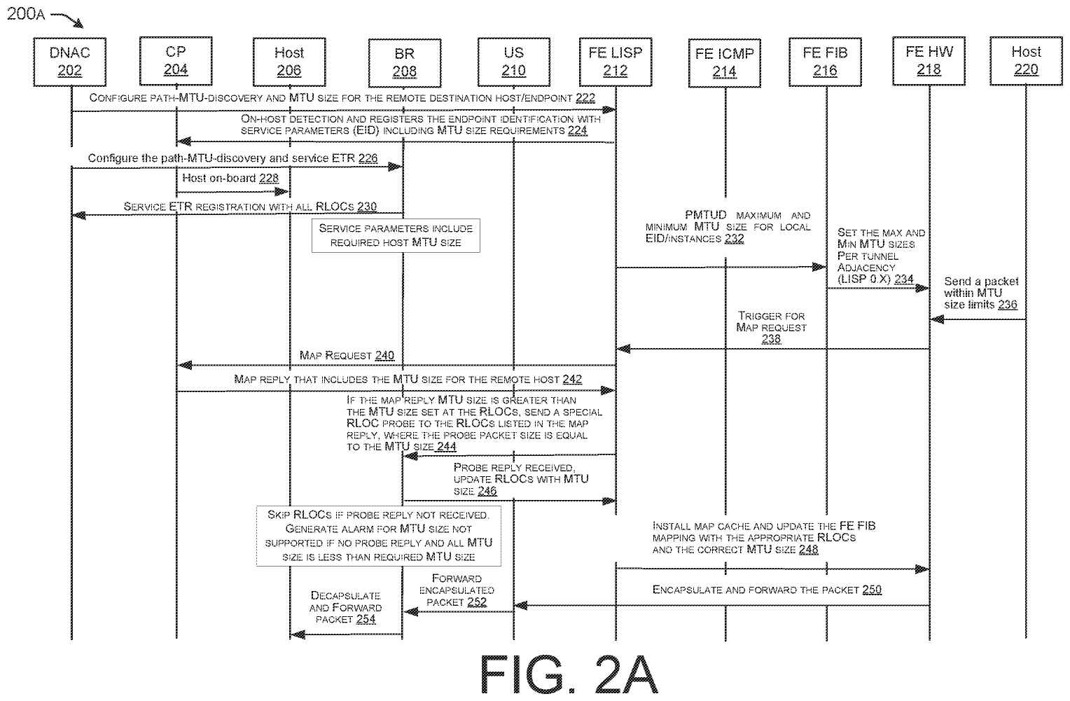

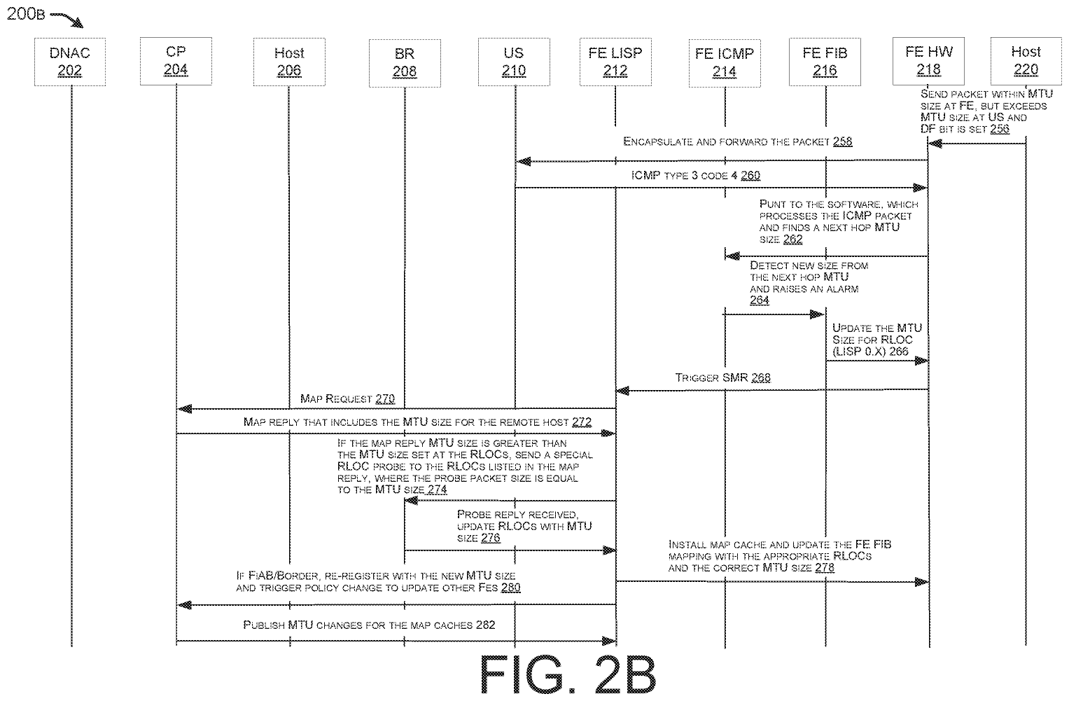

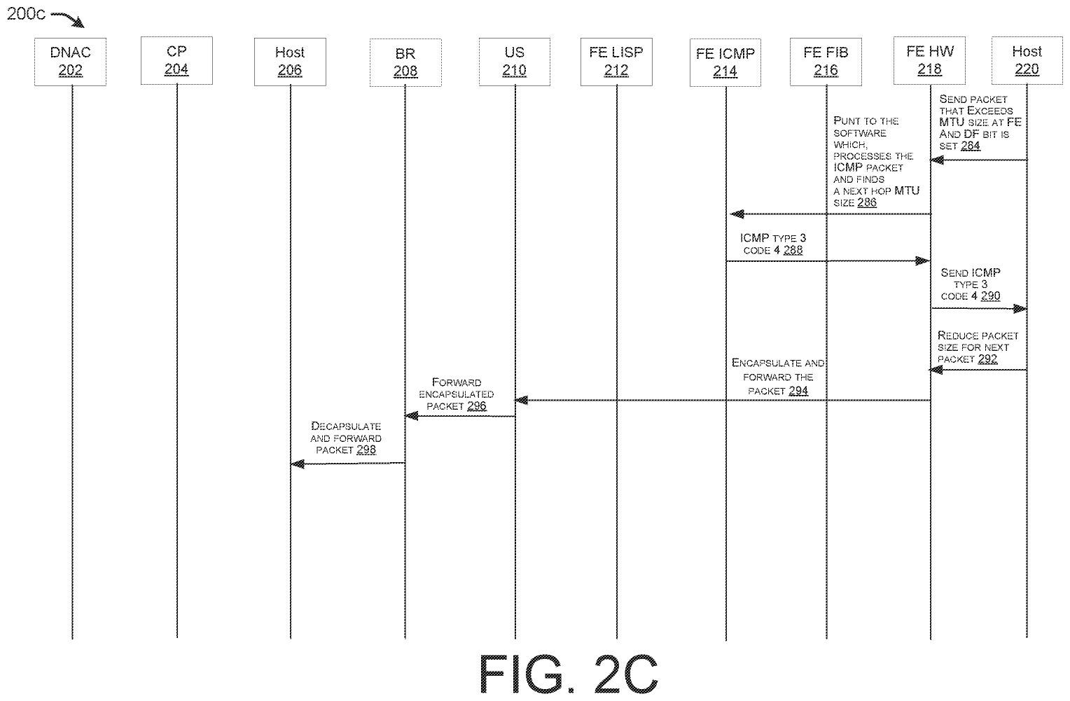

FIGS. 2A-2C schematically illustrate example workflows 200a, 200b, and 200c for service and/or application specific underlay path selection in fabric access networks, in accordance with the techniques and architecture described herein. The example workflow 200 is provided with respect to selecting underlay paths in a LISP-based SDA fabric network based on MTU requirements but may be extended to any service requirements for selecting underlay paths and may be implemented via any pull-based overlay software defined networking (SDN) network/protocols, for example, border gateway protocol (BGP)/ethernet virtual private network (EVPN), e.g., protocols that operate in a centralized fashion.

The flow diagrams 200a, 200b, and 200c include a digital network architecture (DNAC) 202, a control plane (CP) 204, e.g., control plane 108b, a remote destination host 206, e.g., remote destination host 114a, a border (BR) 208, e.g., border 110a, an underlay switch (US) 210, e.g., underlay switch 112a, a forwarding edge (FE) LISP module 212, a forwarding edge (FE) ICMP module 214, a forwarding edge (FE) FIB module 216, forwarding edge (FE) hardware (HW) 218, and a local host 220, e.g., local host 114b. In configurations, the forwarding edge LISP module 212, the forwarding edge ICMP module 214, the forwarding edge FIB module 216, and the forwarding edge hardware 218 are all part of a single network device. In configurations, these components correspond to, and are part of, border 110b of FIG. 1, which in the examples described herein serves as a forwarding edge.

Referring to FIG. 2A, an example workflow 200a is illustrated depicting example actions for service and/or application specific underlay path selection in fabric access networks, e.g., local network 102. At 222, the DNAC configures path-MTU-discovery and MTU size for the remote destination host/endpoint with respect to the forwarding edge LISP module. At 224, the forwarding edge LISP module 212 performs an on-host detection and registers the endpoint identification with service parameters (EID) including MTU size requirements with the control plane 204. At 226, the DNAC 202 configures the path-MTU-discovery and service ETR at the border 208. At 228, the remote destination host 206 onboards with the border 208. At 230, the border 208 performs service ETR registration with all RLOCs. Note the service providers include the required remote destination host (server) MTU size.

At 232, the forwarding edge LISP module 212 performs PMTUD maximum and minimum MTU size for local EID/instances with the forwarding edge FIB module 216. At 234, the forwarding edge FIB module 216 sets the maximum and minimum MTU sizes per tunnel adjacency (for each tunnel LISP 0.X) with the forwarding edge hardware 218. At 236, the local host 220 sends a packet within MTU size limits to the forwarding edge hardware 218. At 238, the forwarding edge hardware 218 sends a trigger for a map request, e.g., a map request message, the forwarding edge LISP module 212.

At 240, the forwarding edge LISP module 212 sends a map request, e.g., a map request message, to the control plane 204. At 242, the control plane 204 sends a map reply, e.g., a map reply message, which includes the MTU size for the remote EID, e.g., the remote destination host 206, to the forwarding edge LISP module 212. At 244, if the map reply MTU size is greater than the MTU size set at the RLOCs, the forwarding edge LISP module 212 sends a special RLOC probe/ping, e.g., verification probe 118, to the RLOCs listed in the map reply, where the probe/ping packet size is equal to the MTU size. This probe is sent to the border 208. At 246, the border 208 sends a probe/ping reply indicating that the probe/ping was received. The probe/ping reply is sent to the forwarding edge LISP module 212, wherein the probe/ping reply updates the RLOCs with the MTU size. Note, that step 246 may be skipped if the probe reply is not received, e.g., the probe reply message times out. Thus, this generally indicates that the MTU size is not supported along at least a portion of the path between the forwarding edge LISP module 212 and the border 208.

At 248, once the probe/ping reply is received at the forwarding edge LISP module 212, then the forwarding edge LISP module 212 installs map cache and updates the forwarding edge FIB module mapping with the appropriate RLOCs and the correct MTU size. The map cache is installed on the forwarding edge hardware 218. At 250, the packet is encapsulated by the forwarding edge hardware 218 and forwarded to the underlay switch 210. At 252, the underlay switch 210 forwards the encapsulated packet to the border 208. At 254, the border 208 decapsulates the packet and forwards the packet to the remote destination host (e.g., server) 206.

Referring to FIG. 2B, an example workflow 200b is illustrated depicting example actions when the local host 220 sends a packet that exceeds the MTU size at the underlay switch 210 and the “do not fragment” (DF) bit is set. At 256, the local host 220 sends a packet within the MTU size at the forwarding edge 218, but which exceeds the MTU size at the underlay switch 210 and the “do not fragment” (DF) bit is set. At 258, the forwarding edge hardware 218 encapsulates and forwards the packet. At 260, the underlay switch 210 sends an ICMP type 3 code 4 message indicating that the packet is too large. This message is sent to the forwarding edge hardware 218. At 262, the forwarding edge hardware 218 “punts” to the software, e.g., the forwarding edge ICMP module 214, which processes the ICMP packet and finds a next hop MTU size. At 264, the forwarding edge FIB module 216 detects the new size from the next hop MTU and generally raises an “alarm.” At 266, the forwarding edge FIB module 216 updates the MTU size for RLOC Adjacency (on tunnel LISP0.X) at the forwarding edge hardware 218. AT 268, the forwarding edge hardware 218 triggers SMR.

At 270, the forwarding edge LISP module 212 sends a map request to the control plane 204. At 272, the control plane 208 sends a map reply, e.g., a map reply message, which includes the MTU size for the remote EID, e.g., the remote destination host 206, to the forwarding edge LISP module 212. At 274, if the map reply MTU size is greater than the MTU size set at the RLOCs, the forwarding edge LISP module 212 sends a special RLOC probe/ping to the RLOCs listed in the map reply, where the probe/ping packet size is equal to the MTU size. This probe is sent to the border 208. At 276, the border 208 sends a probe/ping reply indicating that the probe/ping was received. The probe/ping reply is sent to the forwarding edge LISP module 212, wherein the probe/ping reply updates the RLOCs with the MTU size. Note, that step 276 may be skipped if the probe reply is not received, e.g., the probe reply message times out. Thus, this generally indicates that the MTU size is not supported along at least a portion of the path between the forwarding edge LISP module 212 and the border 208.

At 278, once the probe/ping reply is received at the forwarding edge LISP module 212, then the forwarding edge LISP module 212 installs map cache and updates the forwarding edge FIB module mapping with the appropriate RLOCs and the correct MTU size. The map cache is installed on the forwarding edge hardware 218. At 280, if FiAB/Border, re-register with the new MTU size and trigger policy change to update other forwarding edges (borders). At 282, the control plane 204 publishes MTU changes for the map caches to the forwarding edge LISP module 212.

Referring to FIG. 2C, an example workflow 200 is illustrated depicting example actions when the local host 220 sends a packet that exceeds the MTU size at forwarding edge 218 and the “do not fragment” (DF) bit is set. At 284, the local host 220 sends a packet that exceeds the MTU size at the forwarding edge 218 and the “do not fragment” (DF) bit is set. At 286, the forwarding edge hardware 218 “punts” to the software, e.g., the forwarding edge ICMP module 214. At 288, the forwarding edge ICMP module 214 sends an ICMP type 3 code 4 message indicating that the packet is too large. This message is sent towards the local host 220 to the forwarding edge hardware 218. At 290, the forwarding edge hardware 218 sends the ICMP type 3 code 4 message to the local host 220. At 292, the local host 220 reduces the packet size for the next packet and sends the next packet to the forwarding edge hardware 218. At 294, the forwarding edge hardware 218 encapsulates the next packet and sends the next packet to to the underlay switch 210. At 296, the underlay switch 210 forwards the encapsulated packet to the remote destination host 206.

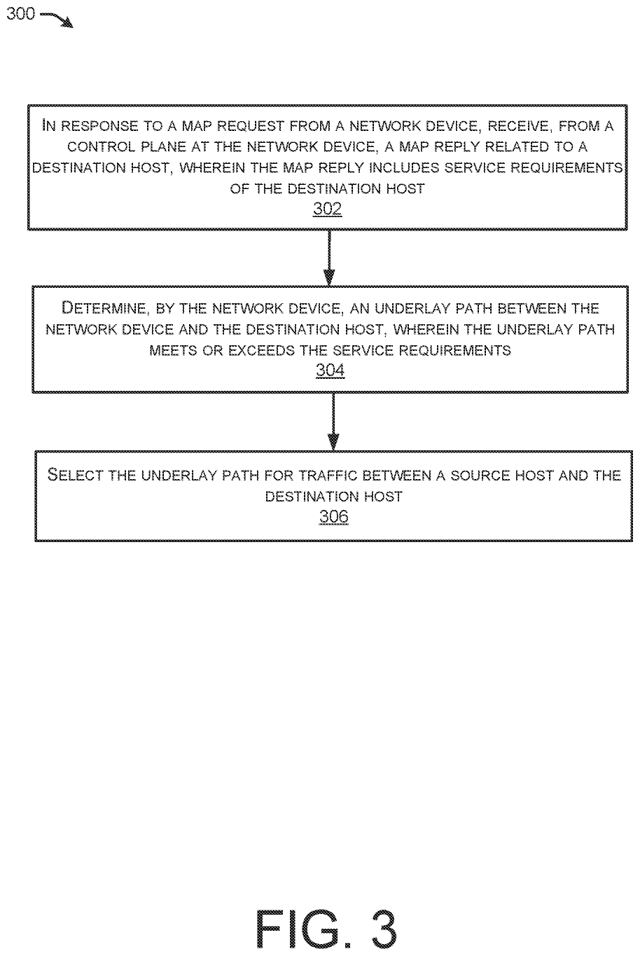

FIG. 3 illustrates a flow diagram of an example method 300 and illustrates aspects of the functions performed at least partly by network devices of a network as described with respect to FIGS. 1 and 2A-2C. The logical operations described herein with respect to FIG. 3 may be implemented (1) as a sequence of computer-implemented acts or program modules running on a computing system, and/or (2) as interconnected machine logic circuits or circuit modules within the computing system.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in FIG. 3 and described herein. These operations can also be performed in parallel, or in a different order than those described herein. Some or all of these operations can also be performed by components other than those specifically identified. Although the techniques described in this disclosure are with reference to specific components, in other examples, the techniques may be implemented by less components, more components, different components, or any configuration of components.

FIG. 3 illustrates a flow diagram of an example method 300 for inducing a precise latency in a network device, e.g., a router, a switch, etc., and observing functions/behavior in the network. In some examples, the method 300 may be performed by a system comprising one or more processors and one or more non-transitory computer-readable media storing computer-executable instructions that, when executed by the one or more processors, cause the one or more processors to perform the method 300.

At 302, in response to a map request from a network device, the network device receives, from a control plane, a map reply related to a destination host, wherein the map reply includes service requirements of the destination host. For example, border 110b may send a map request to control plane 108a. The control plane 108a may send a map reply related to remote destination host 114a to the border 110b, where the map reply includes service requirements, e.g., MTU requirements, of the remote destination host 114a.

At 304, the network device determines an underlay path between the network device and the destination host, wherein the underlay path meets or exceeds the service requirements. For example, the border 110b may determine that path 120b meets or exceeds the service requirements of remote destination host 114a.

At 306, the underlay path is selected for traffic between a source host and the destination host. For example, the border 110b may select path 120b for traffic between the local host 114b and the remote destination host 114a.

Thus, in accordance with techniques and architecture described herein, an egress tunnel router (ETR) registers service requirements of a connected application server, e.g., an end point known by host/device detection, config, or CDC type protocols, to a fabric control plane, e.g., a map server/map resolver (MSMR). The fabric control plane, while replying to a map request from an ingress tunnel router (ITR), sends service parameters in the map reply. While installing a tunnel forwarding path in hardware, i.e., map cache, the ITR may utilize a probing mechanism to ensure that the ITR chooses the right underlay adjacency, e.g., routing locator(s) (RLOC(s)), that can satisfy the service requirements provided by the fabric control plane. Only RLOC(s) that comply with the service requirements are installed in the map cache along with the required service parameters. All additional service parameters in control messages, e.g., locator ID separation protocol (LISP) control messages, are added using vendor specific private type length values (TLVs), e.g., LCAFs in LISP.

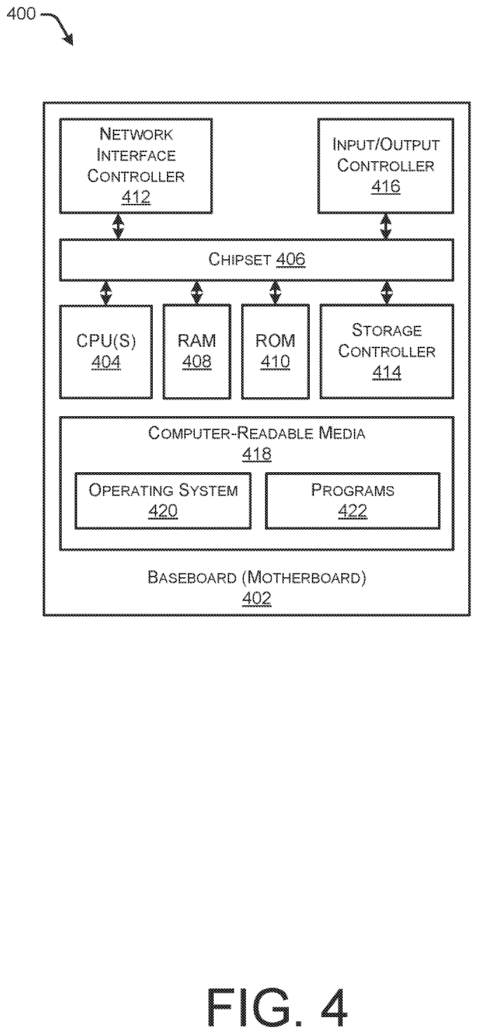

FIG. 4 shows an example computer architecture for a computing device 400 capable of executing program components for implementing the functionality described above. In configurations, one or more of the computing devices 400 may be used to implement one or more of the components of FIGS. 1 and 2A-2C. The computer architecture shown in FIG. 4 illustrates a conventional server computer, workstation, desktop computer, laptop, tablet, network appliance, e-reader, smartphone, or other computing device, and can be utilized to execute any of the software components presented herein. The computing device 400 may, in some examples, correspond to a physical device or resources described herein.

The computing device 400 includes a baseboard 402, or “motherboard,” which is a printed circuit board to which a multitude of components or devices can be connected by way of a system bus or other electrical communication paths. In one illustrative configuration, one or more central processing units (“CPUs”) 404 operate in conjunction with a chipset 406. The CPUs 404 can be standard programmable processors that perform arithmetic and logical operations necessary for the operation of the computing device 400.

The CPUs 404 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 406 provides an interface between the CPUs 404 and the remainder of the components and devices on the baseboard 402. The chipset 406 can provide an interface to a RAM 408, used as the main memory in the computing device 400. The chipset 406 can further provide an interface to a computer-readable storage medium such as a read-only memory (“ROM”) 410 or non-volatile RAM (“NVRAM”) for storing basic routines that help to startup the computing device 400 and to transfer information between the various components and devices. The ROM 410 or NVRAM can also store other software components necessary for the operation of the computing device 400 in accordance with the configurations described herein.

The computing device 400 can operate in a networked environment using logical connections to remote computing devices and computer systems through a network, such as the arrangement 100. The chipset 406 can include functionality for providing network connectivity through a NIC 412, such as a gigabit Ethernet adapter. In configurations, the NIC 412 a smart NIC (based on data processing units (DPUs)) that can be plugged into data center servers to provide networking capability. The NIC 412 is capable of connecting the computing device 400 to other computing devices over networks. It should be appreciated that multiple NICs 412 can be present in the computing device 400, connecting the computer to other types of networks and remote computer systems.

The computing device 400 can be connected to a storage device 418 that provides non-volatile storage for the computer. The storage device 418 can store an operating system 420, programs 422, and data, which have been described in greater detail herein. The storage device 418 can be connected to the computing device 400 through a storage controller 414 connected to the chipset 406. The storage device 418 can consist of one or more physical storage units. The storage controller 414 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computing device 400 can store data on the storage device 418 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 418 is characterized as primary or secondary storage, and the like.

For example, the computing device 400 can store information to the storage device 418 by issuing instructions through the storage controller 414 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 400 can further read information from the storage device 418 by detecting the physical states or characteristics of one or more particular locations within the physical storage units.

In addition to the mass storage device 418 described above, the computing device 400 can have access to other computer-readable storage media to store and retrieve information, such as program modules, data structures, or other data. It should be appreciated by those skilled in the art that computer-readable storage media is any available media that provides for the non-transitory storage of data and that can be accessed by the computing device 400. In some examples, the operations performed by the cloud network, and or any components included therein, may be supported by one or more devices similar to computing device 400. Stated otherwise, some or all of the operations described herein may be performed by one or more computing devices 400 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 418 can store an operating system 420 utilized to control the operation of the computing device 400. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 418 can store other system or application programs and data utilized by the computing device 400.

In one embodiment, the storage device 418 or other computer-readable storage media is encoded with computer-executable instructions which, when loaded into the computing device 400, transform the computer from a general-purpose computing system into a special-purpose computer capable of implementing the embodiments described herein. These computer-executable instructions transform the computing device 400 by specifying how the CPUs 404 transition between states, as described above. According to one embodiment, the computing device 400 has access to computer-readable storage media storing computer-executable instructions which, when executed by the computing device 400, perform the various processes described above with regard to FIGS. 1 and 2A-2C. The computing device 400 can also include computer-readable storage media having instructions stored thereupon for performing any of the other computer-implemented operations described herein.

The computing device 400 can also include one or more input/output controllers 416 for receiving and processing input from a number of input devices, such as a keyboard, a mouse, a touchpad, a touch screen, an electronic stylus, or other type of input device. Similarly, an input/output controller 416 can provide output to a display, such as a computer monitor, a flat-panel display, a digital projector, a printer, or other type of output device. It will be appreciated that the computing device 400 might not include all of the components shown in FIG. 4, can include other components that are not explicitly shown in FIG. 4, or might utilize an architecture completely different than that shown in FIG. 4.

The computing device 400 may support a virtualization layer, such as one or more virtual resources executing on the computing device 400. In some examples, the virtualization layer may be supported by a hypervisor that provides one or more virtual machines running on the computing device 400 to perform functions described herein. The virtualization layer may generally support a virtual resource that performs at least portions of the techniques described herein.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
in response to a map request from a network device, receiving, from a control plane at the network device, a map reply related to a destination host, wherein the map reply includes service requirements of the destination host;
determining, by the network device, an underlay path between the network device and the destination host, wherein the underlay path meets or exceeds the service requirements; and
selecting the underlay path for traffic between a source host and the destination host.

2. The method of claim 1, wherein determining the underlay path comprises:
in response to determining the underlay path is not located in a cache, sending, by the network device for the destination host, a probe message; and
based at least in part on receiving a reply message, determining the underlay path.

3. The method of claim 1, further comprising:
verifying the underlay path; and
saving, by the network device in a cache, the underlay path,
wherein determining the underlay path comprises determining the underlay path is located in the cache.

4. The method of claim 3, wherein verifying the underlay path comprises:
sending, by the network device for the destination host, a probe message; and
based at least in part on receiving a reply message, verifying the underlay path.

5. The method of claim 1, wherein the service requirements comprise one or more of a maximum transmission unit (MTU) specification for packets, network bandwidth, network congestion, network loss delay, network quality of service (QoS), or class of service (CoS) specifications for packets.

6. The method of claim 5, further comprising:
receiving, from a local host at a border within a network that includes the network device, a packet having a size exceeding the MTU specification for at least a portion of the underlay path located within the network; and
forwarding, by the border, a message to the local host instructing the local host to adjust packet sizes for subsequently transmitted packets.

7. The method of claim 1, wherein the underlay path is a first underlay path and the method further comprises:
determining the first underlay path no longer satisfies the service requirements; and
determining a second underlay path.

8. The method of claim 7, wherein determining the second underlay path comprises:
in response to determining the second underlay path is not located in a cache, sending, by the network device to the destination host, a probe message; and
based at least in part on receiving a reply message from the destination host, determining the second underlay path.

9. The method of claim 7, further comprising:
verifying the second underlay path;
saving, by the network device in a cache, the second underlay path; and
deleting the first underlay path from the cache,
wherein determining the underlay path comprises determining the underlay path is located in the cache.

10. The method of claim 9, wherein verifying the second underlay path comprises:
sending, by the network device for the destination host, a probe message; and
based at least in part on receiving a reply message, verifying the second underlay path.

11. A system comprising:
one or more processors; and
one or more non-transitory computer-readable media storing computer-executable instructions that, when executed by the one or more processors, cause the one or more processors to perform actions comprising:
in response to a map request from a network device, receiving, from a control plane at the network device, a map reply related to a destination host, wherein the map reply includes service requirements of the destination host;
determining, by the network device, an underlay path between the network device and the destination host, wherein the underlay path meets or exceeds the service requirements; and
selecting the underlay path for traffic between a source host and the destination host.

12. The system of claim 11, wherein determining the underlay path comprises:
in response to determining the underlay path is not located in a cache, sending, by the network device for the destination host, a probe message; and
based at least in part on receiving a reply message, determining the underlay path.

13. The system of claim 11, wherein the actions further comprise:
verifying the underlay path; and
saving, by the network device in a cache, the underlay path,
wherein determining the underlay path comprises determining the underlay path is located in the cache.

14. The system of claim 13, wherein verifying the underlay path comprises:
sending, by the network device for the destination host, a probe message; and
based at least in part on receiving a reply message, verifying the underlay path.

15. The system of claim 11, wherein the service requirements comprise one or more of a maximum transmission unit (MTU) specification for packets, network bandwidth, network congestion, network loss delay, network quality of service (QoS), or class of service (CoS) specifications for packets.

16. The system of claim 15, wherein the actions further comprise:
receiving, from a local host at a border within a network that includes the network device, a packet having a size exceeding the MTU specification for at least a portion of the underlay path located within the network; and
forwarding, by the border, a message to the local host instructing the local host to adjust packet sizes for subsequently transmitted packets.

17. The system of claim 11, wherein the underlay path is a first underlay path and the actions further comprise:
determining the first underlay path no longer satisfies the service requirements; and
determining a second underlay path.

18. The system of claim 17, wherein determining the second underlay path comprises:
in response to determining the second underlay path is not located in a cache, sending, by the network device for the destination host, a probe message; and
based at least in part on receiving a reply message, determining the second underlay path.

19. One or more non-transitory computer-readable media storing computer-executable instructions that, when executed by one or more processors, cause the one or more processors to perform actions comprising:
in response to a map request from a network device, receiving, from a control plane at the network device, a map reply related to a destination host, wherein the map reply includes service requirements of the destination host;
determining, by the network device, an underlay path between the network device and the destination host, wherein the underlay path meets or exceeds the service requirements; and
selecting the underlay path for traffic between a source host and the destination host.

20. The one or more non-transitory computer-readable media of claim 19, wherein determining the underlay path comprises:
in response to determining the underlay path is not located in a cache, sending, by the network device for the destination host, a probe message; and
based at least in part on receiving a reply message, determining the underlay path.
